(19) United States
(12) Patent Application Publication
(10) Pub. No.: US 2006/0244365 A1
(43) Pub. Date: Nov. 2, 2006

(54) Electron emission device and its method of fabrication, and electron emission display including the electron emission device

(76) Inventor: Sang-Jin Lee, Suwon-si (KR)

Correspondence Address: Robert E. Bushnell;Suite 300, 1522 K Street, N.W., Washington, DC, 20005, US

(21) Appl. No.: 11/330,232

(22) Filed: Jan. 12, 2006

(30) Foreign Application Priority Data
Feb. 18, 2005 (KR) 2005-13463

(51) Int. Cl. H01J 63/04; H01J 1/62

(52) U.S. Cl. 313/496

(57) ABSTRACT

In an electron emission device and its method of fabrication, a plurality of holes is smoothly formed within a limited region, and an ohmic layer connected to a signal line is formed using some of the plurality of holes. The electron emission device includes: a substrate; a first electrode arranged on the substrate; a first insulating layer arranged on the first electrode and having a plurality of first holes; an ohmic layer arranged in at least one of the plurality of first holes and electrically connected to the first electrode; a signal line electrically connected to the ohmic layer and adapted to supply a voltage to the first electrode via the ohmic layer; an emitter arranged in the plurality of first holes excluding the at least one hole having the ohmic layer arranged therein and electrically connected to the first electrode; and a second electrode arranged on the first insulating layer and having a plurality of gate holes corresponding to the plurality of first holes excluding the at least one hole having the ohmic layer arranged therein.

### CLAIM OF PRIORITY

This application makes reference to, incorporates the same herein, and claims all benefits accruing under 35 U.S.C. §119 from an application for ELECTRON EMISSION DEVICE AND MANUFACTURING METHOD AND ELECTRON EMISSION DISPLAY USING SAME earlier filed in the Korean Intellectual Property Office on 18 Feb. 2005 and there duly assigned Serial No. 10-2005-0013463.

### BACKGROUND OF THE INVENTION

1. Field of the Invention

The present invention relates to an electron emission device, its method of fabrication, and an electron emission display including the electron emission device, and more particularly, to an electron emission device, its method of fabrication, and an electron emission display including the electron emission device, in which holes are used to form an ohmic layer connected to a signal line.

2. Discussion of the Related Art

Generally, an electron emission device has a structure in which an emitter electrically connected to a cathode electrode emits electrons by a quantum tunneling effect when an electric field is applied between the cathode electrode and a gate electrode. Such an electron emission device is classified into a thermionic cathode type or a cold cathode type, wherein the thermionic cathode type and the cold cathode type employ a thermionic cathode and a cold cathode, respectively, as an electron emission source.

A cold cathode type electron emission device includes a structure such as a field emitter array (FEA), a surface conduction emitter (SCE), a metal insulator metal (MIM), a metal insulator semiconductor (MIS), a ballistic electron surface emitting (BSE), etc.

Using such electron emission devices, an electron emission display, various backlights, an electron beam unit for lithography, etc. can be realized. Among them, the electron emission display includes a cathode substrate provided with the electron emission device to emit electrons, and an anode substrate provided with a fluorescent layer with which the emitted electrons collide to emit light. In a general electron emission display, the cathode substrate has a matrix shape where cathode electrodes intersect gate electrodes, and a plurality of electron emission devices are defined in these intersection regions. Furthermore, the anode substrate includes the fluorescent layer and an anode electrode connected to the fluorescent layer, so that the anode electrode applies high voltage to the fluorescent layer so as to accelerate the electrons emitted from the electron emission device toward the fluorescent layer formed on the anode substrate.

As an example of the FEA type electron emission device, there is a conventional electron emission device which is disclosed in Korean Patent No. 0370246. Such a conventional FEA type electron emission device includes a substrate, a lower electrode, an ohmic layer, a first insulating layer formed with a hole, an emitter formed within the hole, a gate electrode, a first focusing electrode formed on the same plane as the gate electrode and arranged around the gate electrode, and a second focusing electrode formed on the first focusing electrode across a second insulating layer. With this configuration, the conventional electron emission device enhances a focusing effect of an electron beam emitted from the emitter. Furthermore, the ohmic layer is used for enhancing a contact characteristic between the emitter and the lower electrode.

The first insulating layer of the aforementioned electron emission device is formed having a predetermined thickness between the lower electrode and the gate electrode, thereby insulating the lower electrode from the gate electrode. The lower electrode and the gate electrode are used for supplying an electric field to the emitter. Furthermore, the lower electrode corresponds to a cathode electrode. Such an insulating layer can be formed by a thick film growing method that prints and anneals an insulating material, or a thin film growing method such as Chemical Vapor Deposition (CVD), etc.

The thick film growing method can be used in forming the large-sized and inexpensive insulating layer. However, in the thick film growing method, the resistance of the ohmic layer is varied while the insulating layer is annealed at a high temperature, it is difficult to form the ohmic layer having a required resistance. Particularly, in the thick film growing method, the insulating layer is thickly formed, so that the diameter of the hole becomes larger. Furthermore, the hole of the insulating layer has a rough surface, so that a foreign material may be formed in the hole and the holes are not uniform. In the case where the insulating layer having a predetermined thickness is interposed between the cathode electrode and the gate electrode and a predetermined voltage is applied between the cathode electrode and the gate electrode, the withstanding voltage and the temperature of the insulating layer functioning as a dielectric material become higher as the insulating layer gets thicker, thereby increasing the power consumption.

Contrary to the thick film growing method, in the thick film growing method, the ohmic layer is easily formed without an annealing process of a high temperature. However, because the insulating layer is formed thinly, it is difficult to focus the electron beam.

In the conventional electron emission device, it is different to form a desired number of holes, in which the emitters are respectively formed, within a limited region, and it is further difficult to form the ohmic layer through such hole.

### SUMMARY OF THE INVENTION

Accordingly, it is an aspect of the present invention to provide an electron emission device and its method of fabrication, in which a plurality of holes is smoothly formed within a limited region, and an ohmic layer connected to a signal line is formed using some of the plurality of holes.

Another aspect of the present invention is to provide an electron emission display comprising the foregoing electron emission display.

According to one aspect of the present invention, an electron emission device is provided comprising: a substrate; a first electrode arranged on the substrate; a first insulating layer arranged on the first electrode and having a plurality of first holes; an ohmic layer arranged in at least one of the plurality of first holes and electrically connected to the first electrode; a signal line electrically connected to the ohmic layer and adapted to supply a voltage to the first electrode via the ohmic layer; an emitter arranged in the plurality of first holes excluding the at least one hole having the ohmic layer arranged therein and electrically connected to the first electrode; and a second electrode arranged on the first insulating layer and having a plurality of gate holes corresponding to the plurality of first holes excluding the at least one hole having the ohmic layer arranged therein.

The electron emission device preferably further comprises a second insulating layer arranged between the first insulating layer and the second electrode and having a plurality of second holes corresponding to the plurality of first holes excluding the at least one hole having the ohmic layer arranged therein.

The first insulating layer preferably has a thickness in a range of 5 μm to 9 μm, and the second insulating layer preferably has a thickness in a range of 1 μm to 3 μm.

The electron emission device preferably further comprises a grid electrode arranged on the second electrode and having a plurality of control holes corresponding to the plurality of second holes.

The grid electrode preferably comprises a mesh-shaped conductive sheet coated with a third insulating layer.

According to another aspect of the present invention, a method of fabricating an electron emission device is provided, the method comprising: forming a first electrode on a substrate; forming a signal line electrically connected to the first electrode on the substrate, and adapted to supply a voltage to the first electrode; forming a first insulating layer on the first electrode by printing and annealing an insulating material; forming a plurality of first holes in the first insulating layer; forming an ohmic layer in at least one of the plurality of first holes to be electrically connected to the first electrode and the signal line; forming a second electrode in the first insulating layer to have a predetermined shape in a direction intersecting the first electrode; and forming an emitter in the plurality of first holes excluding the at least one hole having the ohmic layer formed therein to be electrically connected to the first electrode.

The method preferably further comprises forming a second insulating layer between the first insulating layer and the second electrode.

According to still another aspect of the present invention, an electron emission display is provided comprising: first and second substrates facing each other; a first electrode arranged on the first substrate; a first insulating layer arranged on the first electrode and having a plurality of first holes; an ohmic layer arranged in at least one of the plurality of first holes and electrically connected to the first electrode; a signal line electrically connected to the ohmic layer and adapted to supply a voltage to the first electrode via the ohmic layer; an emitter arranged in the plurality of first holes excluding the at least one hole having the ohmic layer arranged therein and electrically connected to the first electrode; a second electrode arranged on the first insulating layer and having a plurality of gate holes corresponding to the plurality of first holes excluding the at least one hole having the ohmic layer arranged therein; a fluorescent layer arranged on the second substrate and adapted to emit light in response to collisions with electrons emitted from the emitter; and an anode electrode arranged on the second substrate and connected to the fluorescent layer.

The electron emission display preferably further comprises a second insulating layer arranged between the first insulating layer and the second electrode and having a plurality of second holes corresponding to the plurality of first holes excluding the at least one hole having the ohmic layer arranged therein.

The first insulating layer preferably has a thickness in a range of 5 μm to 9 μm, and the second insulating layer preferably has a thickness in a range of 1 μm to 3 μm.

The electron emission device preferably further comprises a grid electrode arranged on the second electrode and having a plurality of control holes corresponding to the plurality of second holes.

The grid electrode preferably comprises a mesh-shaped conductive sheet coated with a third insulating layer.

The emitter preferably comprises at least one of carbon nanotubes, graphite, graphite nanofibers, diamond-like-carbon, C60, silicon nanowires, and combinations thereof.

The electron emission display preferably further comprises a dark region arranged the second substrate and adapted to not emit light in response to electrons emitted from the emitter colliding therewith.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partial sectional view of a conventional electron emission device;

FIG. 2 is a partial plan view of an electron emission device according to an embodiment of the present invention;

FIG. 3 is a partial sectional view of the electron emission device according to an embodiment of the present invention;

FIGS. 4A through 4C are views of a method of fabricating the electron emission device according to an embodiment of the present invention; and

FIG. 5 is a sectional view of an electron emission display using the electron emission device according to an embodiment of the present invention.

### DETAILED DESCRIPTION OF THE INVENTION

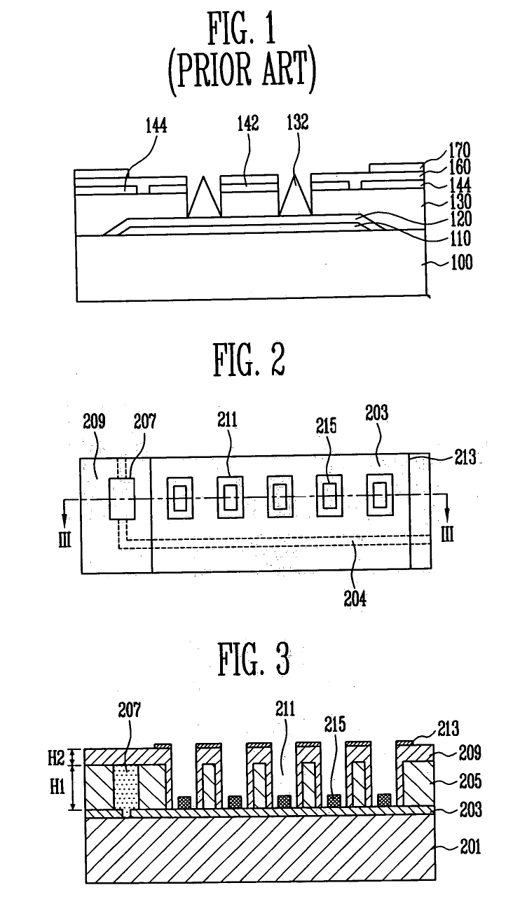

FIG. 1 is a sectional view of a conventional FEA type electron emission device. Referring to FIG.1, the conventional electron emission device includes a substrate 100, a lower electrode 110, an ohmic layer 120, a first insulating layer 130 formed with a hole, an emitter 132 formed within the hole, a gate electrode 142, a first focusing electrode 144 formed on the same plane as the gate electrode 142 and arranged around the gate electrode 142, and a second focusing electrode 170 formed on the first focusing electrode 144 across a second insulating layer 160. With this configuration, the conventional electron emission device enhances a focusing effect of an electron beam emitted from the emitter 132. Furthermore, the ohmic layer 120 is used for enhancing a contact characteristic between the emitter 132 and the lower electrode 110.

The first insulating layer 130 of the aforementioned electron emission device is formed having a predetermined thickness between the lower electrode 110 and the gate electrode 142, thereby insulating the lower electrode 110 from the gate electrode 142. The lower electrode 110 and the gate electrode 142 are used for supplying an electric field to the emitter 132. Furthermore, the lower electrode 110 corresponds to a cathode electrode. Such an insulating layer can be formed by a thick film growing method that prints and anneals an insulating material, or a thin film growing method such as Chemical Vapor Deposition (CVD), etc.

Hereinafter, exemplary embodiments according to the present invention will be described with reference to the accompanying drawings. When a first layer is described as being placed on a second layer, the first layer can be directly placed on the second layer or a third layer can be interposed between the first layer and the second layer. Furthermore, the thickness and the size of each layer are exaggerated for convenience of description and clarity. Also, like numerals refer to like elements throughout.

FIG. 2 is a partial plan view of an electron emission device according to an embodiment of the present invention, and FIG. 3 is a partial sectional view of the electron emission device according to an embodiment of the present invention.

Referring to FIGS. 2 and 3, the electron emission device includes a substrate 201, a first electrode 203, a signal line 204, a first insulating layer 205, an ohmic layer 207, a second insulating layer 209, a first hole 211, a second electrode 213, and an emitter 215.

The substrate 201 uses a glass substrate or a silicon substrate. Particularly, when the emitter 215 is formed using a Carbon NanoTube (CNT) paste, the substrate 201 uses a glass substrate for rear-side exposure.

The first electrode 203 is formed having a stripe shape or a divided stripe shape. When the emitter 215 is formed by a rear-side exposure, the first electrode 203 is formed as a transparent electrode, e.g., Indium Tin Oxide (ITO). In this embodiment, the first electrode 203 is used as a cathode electrode of the electron emission device.

The signal line 204 is patterned when the first electrode 203 is formed, or formed on the substrate 201 by processing a conductive material. Furthermore, the signal line 204 is electrically connected to the ohmic layer 207. The signal line 204 connects the first electrode 203 of the electron emission device to a driver or a control circuit. Also, the signal line 204 is connected to the first electrode of each electron emission device, and transmits a data signal or a scan signal from a data driver (not shown) or a scan driver (not shown) to a predetermined electron emission device.

The first insulating layer 205 is formed on the substrate 201 and the first electrode 203, and electrically insulates the first electrode 203 from the second electrode 213. The first insulating layer 205 is made of an insulating material, e.g., a glass material containing a combination of PbO and SiO₂, and is formed with a plurality of first holes 211 to partially expose the first electrode 203. The first insulating layer 205 for beam-focus has a thickness “H1” and is formed by a thick film growing method.

The first hole 211 is formed in a region where the first electrode 203 intersects the second electrode 213. The first hole 211 is formed through the first and second insulating layers 5 205 and 209. According to an embodiment of the present invention, many first holes 211 can be formed within a limited region, e.g., a region corresponding to a pixel unit of the electron emission display.

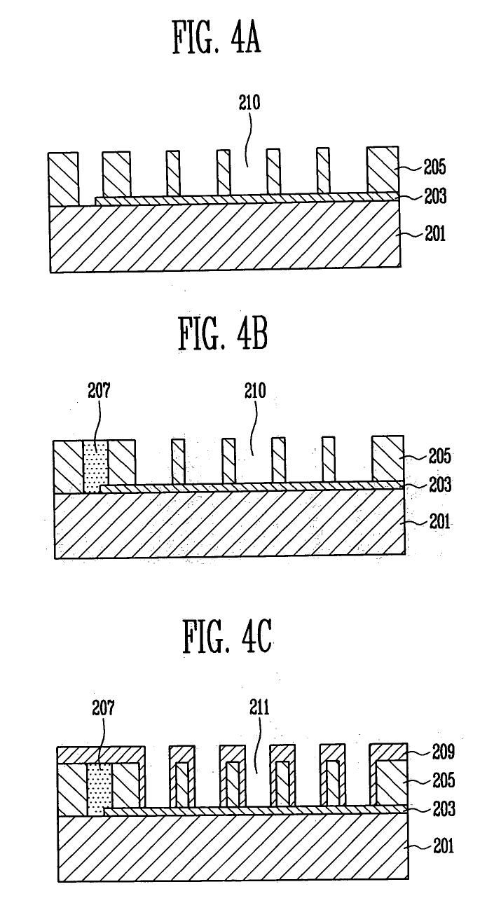

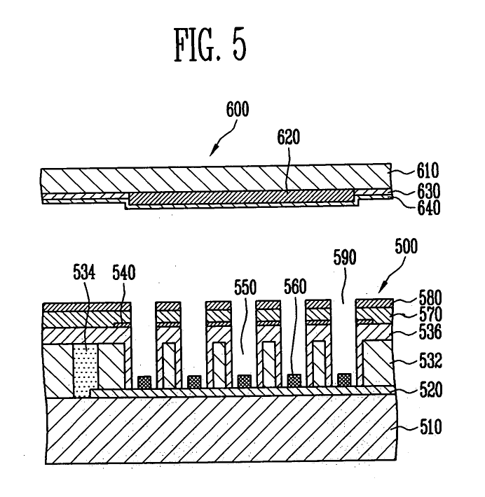

The ohmic layer 207 is formed to enhance an electrical contact characteristic between the first electrode 203 and the signal line 204 connected to the first electrode 203 and to transmit a predetermined signal to the signal line 204, thereby securing the durability and the uniformity of the electron emission device. In this embodiment, the ohmic layer 207 is formed using at least one hole from among the plurality of holes (refer to “210” of FIG. 4A) formed on the first insulating layer 205. The emitter 215 is formed in the other holes.

The second insulating layer 209 is formed on the first insulating layer 205 and the ohmic layer 207, and formed with a second hole 211 corresponding to the hole of the first insulating layer 205. For example, the second insulating layer 209 is formed as a Spin on Glass (SOG) insulating layer. Such an SOG layer is generally used in a thin film process of 1 μm or below. The thickness “H2” of the second insulating layer is formed by repeating an SOG layer depositing process three to five times.

The second electrode 213 is formed on the second insulating layer 209 and has a predetermined shape. For example, the second electrode 213 has a stripe shape extending in a direction intersecting the first electrode 203, and is formed around the second hole 211 of the second insulating layer 209. In this embodiment, the second electrode 213 is used as a gate electrode of a cathode substrate. The second electrode 213 is made of metal having good conductivity, e.g. at least one metal selected from the group consisting of gold (Au), silver (Ag), platinum (Pt), aluminum (Al), chrome (Cr), and an alloy thereof. The second electrode 213 intersects the first electrode 205. Furthermore, a region where the second electrode 213 intersects the first electrode 205 corresponds to a pixel region of the electron emission display.

The emitter 215 is formed within the second hole 211 of the second insulating layer 209, and is electrically connected to the first electrode 203 exposed through the second hole 211. The emitter 215 is made of a carbon material or a material having a size of about one nanometer (nm). For example, the emitter 215 is made of Carbon NanoTubes (CNTs), graphite, graphite nanofibers, diamond-like-carbon, C60, silicon nanowires, or a combination thereof.

According to an embodiment of the present invention, the electron emission device can further include a grid electrode (refer to “580” of FIG. 5). The grid electrode can be provided as a mesh-shaped conductive sheet arranged on an additional insulating layer (refer to “570” of FIG. 5) formed on both the second insulating layer 209 and the second electrode 213.

With this configuration, the electron emission device according to an embodiment of the present invention has a different structure from that of the conventional electron emission device. That is, the conventional electron emission device has the structure in which the diameter of the hole becomes larger as the insulating layer gets thicker, and therefore it is difficult to form the ohmic layer for the beam-focus through the hole of the thick insulating layer having the thickness proper. On the other hand, the electron emission device according to an embodiment of the present invention has a structure in which a suitable number of holes having a proper thickness are formed in the first insulating layer, and the ohmic layer is formed through at least one hole among the plurality of formed holes, so that it is easy to form the ohmic layer. Furthermore, according to an embodiment of the present invention, the ohmic layer is formed after the first insulating layer has been annealed, so that the ohmic layer is not deformed due to the annealing process of the first insulating layer.

In the conventional electron emission device, the insulating layer is thickly formed by a general thick film growing process, so that the hole formed in the insulating layer has a rough surface, thereby limiting or complicating the following process for forming the emitter. On the other hand, the electron emission device according to an embodiment of the present invention has a structure in which the ohmic layer is formed in at least one hole of the first insulating layer and the second insulating layer is additionally formed on the first insulating layer and the ohmic layer, so that the hole is smoothly formed throughout the first and second insulating layers. Thus, when the emitter is formed by the following rear-side exposure process, the defective emitter due to the foreign material on the inner surface of the hole is decreased.

FIGS. 4A through 4C are views of a method of fabricating an electron emission device according to an embodiment of the present invention.

Referring to FIG. 4A, a conductive material is deposited and lithography-processed on the substrate 201, thereby patterning the first electrode 203 and the signal line (refer to “204” of FIG. 2). The first electrode 203 and the signal line are electrically disconnected. The signal line is used for transmitting a signal to the first electrode 203 for driving the electron emission device.

Then, an insulating material is printed and annealed on the substrate 201 having the first electrode 203 and the signal line, thereby forming the first insulating layer 205. The insulating material is thickly printed and has a thickness of about 10 μm to 15 μm, and is then annealed to have a thickness of about 5 μm to 9 μm, thereby forming the first insulating layer 205. The insulating material includes a glass material containing a combination of PbO and SiO₂. In this process, the thickness of the insulating layer is secured to smoothly focus a beam emitted from the electron emission device.

Then, the plurality of holes 210 is formed in the first insulating layer 205 through the lithography process. In this process, the inner surface of the hole 210 is roughly formed. Therefore, the rough surface of the hole 210 may form a short-circuit when the emitter is formed by supplying the rear-side exposure to the CNT paste. However, this problem is solved by the second insulating layer 209.

Then, as shown in FIG. 4B, the ohmic layer 207 is formed by filling at least one hole 210 with a predetermined ohmic material. The ohmic layer 207 is electrically connected to the first electrode 203 and the signal line. Thus, the ohmic layer 207 enhances the electrical contact characteristic between the signal line and the first electrode 203, thereby securing the durability and the uniformity of the electron emission device.

Then, as shown in FIG. 4C, the second insulating layer 209 is formed by repeatedly depositing the SOG layer several times on the first insulating layer 205 and the ohmic layer 207. The second insulating layer 209 has a thickness of 1 μm to 3 μm. Then, the second hole 211 is formed on the second insulating layer 209 by the lithography process. The inner surface of the second hole 211 is smoothly formed by the thin film growing process.

Then, the second electrode is formed on the second insulating layer 209 and the emitter is formed in the second hole 211, which is not shown.

Thus, in the electron emission device according to an embodiment of the present invention, an enough number of holes is formed on the insulating layer having a thickness proper for the beam-focus, and the ohmic layer having a desired resistance is formed in at least one of the holes, thereby easily fabricating the electron emission device having excellent properties.

FIG. 5 is a sectional view of an electron emission display using the electron emission device according to an embodiment of the present invention.

Referring to FIG. 5, the electron emission display according to an embodiment of the present invention includes a cathode substrate 500 and an anode substrate 600. The cathode substrate 500 is used as an electron emission substrate having an electron emission region thereon, and the anode substrate 600 is used as an image forming substrate having an image display region displaying a predetermined image thereon due to collision with electrons emitted from the electron emission region of the cathode substrate 500. Furthermore, the cathode substrate 500 includes the aforementioned electron emission device.

In more detail, the cathode substrate 500 includes a rear substrate 510, a first electrode 520, a signal line (refer to “204” of FIG. 2), a first insulating layer 532, an ohmic layer 534, a second insulating layer 536, a second electrode 540, a hole 550, and an emitter 560. The signal line is used as a wiring line to transmit a predetermined signal for driving the emitter 560 to the first electrode 520, and the ohmic layer 534 is used for enhancing the electrical contact characteristic between the signal line and the first electrode 520. The cathode substrate has the same configuration as the aforementioned electron emission device, so that repetitive descriptions have been omitted.

The cathode substrate 500 additionally includes a third insulating layer 570 and a grid electrode 580. The third insulating layer 570 is formed on the second electrode 540 of the cathode substrate 500. The third insulating layer 570 is interposed between the second electrode 540 and the adjacent second electrode, or is arranged partially overlapping with both the second electrode 540 and the adjacent second electrode in a region as long as it is not affected by the entire parasitic capacitance of the cathode substrate 500. Preferably, the third insulating layer 570 has a thickness ranging from 10 μm to 40 μm to enhance the beam-focus of the grid electrode.

The grid electrode 580 is formed on the cathode substrate 500, and formed with the second hole 590 through which the electrons emitted from the emitter 560 pass. Furthermore, the grid electrode 580 focuses the electrons traveling toward a fluorescent layer 620 of the anode substrate 600, and prevents the electrodes from being damaged due to arcing. For example, the grid electrode 580 protects the first electrode 540, the emitter 560, the first electrode 520, and the like from an anode electric field due to a high voltage supplied to the anode electrode 640. The grid electrode 580 is formed as a mesh-shaped conductive sheet on the cathode substrate 500. Also, the grid electrode 580 can include a predetermined insulating layer (not shown) formed thereon. Preferably, the insulating layer formed on the surface of the grid electrode 580 includes PbO and SiO₂ to enhance the withstanding voltage characteristics between the first electrode 520, the second electrode 540 and the grid electrode 580.

The anode substrate 600 includes the front substrate 610 facing the rear substrate 510 of the cathode substrate 500, the fluorescent layer 620 formed in the effective region of the front substrate 610, and a metal thin film 640 formed on the front substrate 610 and the fluorescent layer 620.

The front substrate 610 includes a transparent material such a glass or the like.

The fluorescent layer 620 is formed as an emission region within the effective region of the front substrate 610, and emits light due to the collision with electrons emitted from the emitter 560 of the cathode substrate 500. The fluorescent layer 620 is formed on one side of the front substrate 610, and has a predetermined shape, e.g., a stripe shape.

The metal thin film 640 is employed as the anode electrode to supply a high voltage to the fluorescent layer 620. The metal thin film 6 40 is formed between the front substrate 610 and the fluorescent layer 620. Furthermore, the metal thin film 640 more effectively focuses the electrons emitted from the emitter 560, and reflects the light toward the front substrate 610, thereby enhancing a reflecting efficiency.

Furthermore, the anode substrate 600 additionally includes an optional dark region 630 formed as a non light emission region within the effective region of the front substrate 610. The dark region 230 is formed between the fluorescent layers 620 forming pixels, and absorbs/intercepts external light to prevent cross-talk, thereby enhancing contrast.

Thus, the present invention provides an electron emission display using the electron emission device having good characteristics, so that the durability and the uniform brightness of the electron emission display are secured.

In the foregoing embodiment, the electron emission device is applied to the cathode substrate of the electron emission display. However, the present invention is not limited thereto. Alternatively, the electron emission device according to an embodiment of the present invention can be applied to various backlights, and an electron beam unit for lithography, etc. as well as the electron emission display.

As described above, the present invention provides an electron emission device and its method of fabrication, in which a plurality of holes is formed within a limited region, and an ohmic layer connected to a signal line is formed using some holes, thereby securing the durability and the uniformity of the electron emission device.

Furthermore, the present invention provides an electron emission display capable of reducing power consumption due to the dielectric of an insulating layer.

While the present invention has been described in connection with certain exemplary embodiments, it is to be understood by those skilled in the art that the present invention is not limited to the disclosed embodiments, but, on the contrary, is intended to cover various modifications included within the spirit and scope of the appended claims.

What is claimed is:

1. An electron emission device, comprising:
a substrate;
a first electrode arranged on the substrate;
a first insulating layer arranged on the first electrode and having a plurality of first holes;
an ohmic layer arranged in at least one of the plurality of first holes and electrically connected to the first electrode;
a signal line electrically connected to the ohmic layer and adapted to supply a voltage to the first electrode via the ohmic layer;
an emitter arranged in the plurality of first holes excluding the at least one hole having the ohmic layer arranged therein and electrically connected to the first electrode; and
a second electrode arranged on the first insulating layer and having a plurality of gate holes corresponding to the plurality of first holes excluding the at least one hole having the ohmic layer arranged therein.

2. The electron emission device according to claim 1, further comprising a second insulating layer arranged between the first insulating layer and the second electrode and having a plurality of second holes corresponding to the plurality of first holes excluding the at least one hole having the ohmic layer arranged therein.

3. The electron emission device according to claim 2, wherein the first insulating layer has a thickness in a range of 5 μm to 9 μm, and wherein the second insulating layer has a thickness in a range of 1 μm to 3 μm.

4. The electron emission device according to claim 2, further comprising a grid electrode arranged on the second electrode and having a plurality of control holes corresponding to the plurality of second holes.

5. The electron emission device according to claim 4, wherein the grid electrode comprises a mesh-shaped conductive sheet coated with a third insulating layer.

6. A method of fabricating an electron emission device, the method comprising:
forming a first electrode on a substrate;
forming a signal line electrically connected to the first electrode on the substrate, and adapted to supply a voltage to the first electrode;
forming a first insulating layer on the first electrode by printing and annealing an insulating material;
forming a plurality of first holes in the first insulating layer;
forming an ohmic layer in at least one of the plurality of first holes to be electrically connected to the first electrode and the signal line;
forming a second electrode in the first insulating layer to have a predetermined shape in a direction intersecting the first electrode; and
forming an emitter in the plurality of first holes excluding the at least one hole having the ohmic layer formed therein to be electrically connected to the first electrode.

7. The method according to claim 6, further comprising forming a second insulating layer between the first insulating layer and the second electrode.

8. An electron emission display, comprising:
first and second substrates facing each other;
a first electrode arranged on the first substrate;
a first insulating layer arranged on the first electrode and having a plurality of first holes;
an ohmic layer arranged in at least one of the plurality of first holes and electrically connected to the first electrode;
a signal line electrically connected to the ohmic layer and adapted to supply a voltage to the first electrode via the ohmic layer;
an emitter arranged in the plurality of first holes excluding the at least one hole having the ohmic layer arranged therein and electrically connected to the first electrode;
a second electrode arranged on the first insulating layer and having a plurality of gate holes corresponding to the plurality of first holes excluding the at least one hole having the ohmic layer arranged therein;
a fluorescent layer arranged on the second substrate and adapted to emit light in response to collisions with electrons emitted from the emitter; and
an anode electrode arranged on the second substrate and connected to the fluorescent layer.

9. The electron emission display according to claim 8, further comprising a second insulating layer arranged between the first insulating layer and the second electrode and having a plurality of second holes corresponding to the plurality of first holes excluding the at least one hole having the ohmic layer arranged therein.

10. The electron emission display according to claim 9, wherein the first insulating layer has a thickness in a range of 5 μm to 9 μm, and wherein the second insulating layer has a thickness in a range of 1 μm to 3 μm.

11. The electron emission device according to claim 9, further comprising a grid electrode arranged on the second electrode and having a plurality of control holes corresponding to the plurality of second holes.

12. The electron emission display according to claim 11, wherein the grid electrode comprises a mesh-shaped conductive sheet coated with a third insulating layer.

13. The electron emission display according to claim 8, wherein the emitter comprises at least one of carbon nanotubes, graphite, graphite nanofibers, diamond-like-carbon, C60, silicon nanowires, and combinations thereof.

14. The electron emission display according to claim 8, further comprising a dark region arranged the second substrate and adapted to not emit light in response to electrons emitted from the emitter colliding therewith.
